(19) United States
(12) Patent Application Publication
(10) Pub. No.: US 2008/0103843 A1
(43) Pub. Date: May 1, 2008

(54) INTEGRATING INFORMATION FOR MAINTENANCE

(75) Inventors: Joerg Goeppert, Karlsruhe (DE); Thomas Kessler, St. Leon-Rot (DE)

Correspondence Address: FISH & RICHARDSON, P.C., PO BOX 1022, MINNEAPOLIS, MN, 55440-1022, US

(73) Assignee: SAP AG-Germany, Waldorf (DE)

(21) Appl. No.: 11/553,928

(22) Filed: Oct. 27, 2006

(51) Int. Cl. G06F 9/44

(52) U.S. Cl. 705/7

(57) ABSTRACT

Systems and techniques for integrating information for the planning and performance of maintenance activities are described. In one aspect, a method includes receiving a collection of descriptions of maintenance tasks in an enterprise, accessing one or more data stores to receive asset information characterizing assets in the enterprise, process information characterizing assets involved in processes of the enterprise, and process value information characterizing values of the processes to the enterprise, integrating the asset information, the process information, and the process value information to assign costs associated with performance of each of the maintenance tasks, generating a work list including a subset of the collection of maintenance tasks based on the assigned costs, and making the work list available over one or more output devices.

### BACKGROUND

This disclosure relates to the integration of information for the planning and performance of maintenance activities.

Maintenance activities are generally performed to keep a device or a system in proper working order. Maintenance activities include the repair of inoperative devices and systems, as well as prophylactic measures intended to reduce the need for repair in the future. Maintenance activities can thus be one time events or they can recur during an operational lifespan.

### SUMMARY

Systems and techniques for integrating information for the planning and performance of maintenance activities are described. In one aspect, a method includes receiving a collection of descriptions of maintenance tasks in an enterprise, accessing one or more data stores to receive asset information characterizing assets in the enterprise, process information characterizing assets involved in processes of the enterprise, and process value information characterizing values of the processes to the enterprise, integrating the asset information, the process information, and the process value information to assign costs associated with performance of each of the maintenance tasks, generating a work list including a subset of the collection of maintenance tasks based on the assigned costs, and making the work list available over one or more output devices.

This and other aspects can include one or more of the following features. The data stores can be accessed to receive human resource information characterizing abilities of maintenance personnel to perform the maintenance tasks. The human resource information, the asset information, the process information, and the process value information can be integrated to assign the costs. The work list can be made available by outputting the work list at an output device on a task-by-task and location-by location basis. The descriptions of maintenance tasks can be descriptions of regularly-scheduled maintenance tasks in the enterprise. A route for maintenance personnel to perform the maintenance tasks on the work list can be planned. Such planning can be based on the costs assigned to each of the maintenance tasks.

The method can also include, after generating the work list, receiving a notification of a malfunction of an asset of the enterprise, accessing and integrating the asset information, the process information, and the process value information to assign a cost associated with a failure to perform a maintenance task responsive to the malfunction, revising the work list to include the maintenance task responsive to the new malfunction, and making the revised work list available to the maintenance personnel over the one or more output devices.

The method can also include, after generating the work list, receiving an indication that maintenance personnel has moved to a new position, accessing and integrating the asset information, the process information, and the process value information to assign revised costs associated with performance of each of the maintenance tasks, revising the work list in light of the revised costs, and making the revised work list available to the maintenance personnel over the one or more output devices.

In another aspect, an article includes one or more machine-readable media storing instructions operable to cause one or more machines to perform operations. The operations can include receiving information characterizing a past performance of maintenance activities, the information characterizing the past maintenance activities, an entity performing the past maintenance activities, one or more assets involved in the past maintenance activities, and the duration of the performance of the past maintenance activities, storing the past performance information in one or more collections of information, integrating the past performance information with information characterizing participation of assets in processes of an enterprise and values of the processes to the enterprise to assign costs to open maintenance tasks of the enterprise, generating a work list including a subset of the open maintenance tasks, and making the work list available.

This and other aspects can include one or more of the following features. The operations can include, after generating the work list, receiving a notification of a malfunction of first asset of the enterprise, accessing and integrating the past performance information with the information characterizing participation of the first asset in processes of the enterprise and values of the processes to the enterprise to assign a cost to a first maintenance task responsive to the malfunction, revising the work list to include the first maintenance task, and making the revised work list available.

The past performance information can be read from a machine-readable tag associated with the one or more assets involved in the past maintenance activities and can characterize the quality of the past performance of the maintenance activities. The past performance information can be stored in data collections associated with different modules of a distributed data processing system.

The travel time between locations where maintenance tasks are performed can also be integrated to assign costs to open maintenance tasks of the enterprise. The availability of equipment or supplies consumed for performance of maintenance tasks can also be integrated to assign costs to open maintenance tasks of the enterprise.

Safety information characterizing safety issues associated with performance of the maintenance tasks can be made available to the maintenance personnel. The work list can be made available to maintenance personnel over one or more handheld front-end devices on a task-by-task basis. The costs can be assigned by multiplying each of one or more elements of the past performance information, the information characterizing participation of assets in processes, and the process values by factors reflective of a cost indicated by that information, and summing the factors to assign the costs to the open maintenance tasks. The work list can be generated by determining a route to be taken by maintenance personnel in the performance of the open maintenance tasks in the work list and/or by selecting the subset of the open maintenance tasks based on maximizing a total cost associated with not performing the selected subset or minimizing a total cost associated with performing the selected subset.

The details of one or more implementations are set forth in the accompanying drawings and the description below. Other features and advantages will be apparent from the description and drawings, and from the claims.

### DESCRIPTION OF DRAWINGS

FIG. 1 is a schematic representation of a distributed data processing system landscape where maintenance information is integrated for the performance of maintenance activities.

FIG. 2 schematically illustrates an example collection of asset master data that can be accessed to plan and coordinate maintenance activities.

FIGS. 3, 4A, 4B schematically illustrate example collections of enterprise resource planning system data that can be accessed to plan and coordinate maintenance activities.

FIG. 5 schematically illustrates an example collection of process control system data that can be accessed to plan and coordinate maintenance activities.

FIG. 6 schematically illustrates an example collection of human capital data that can be accessed to plan and coordinate maintenance activities.

FIG. 7 schematically illustrates an example collection of maintenance data that can be accessed to plan and coordinate maintenance activities.

FIG. 8 schematically illustrates an example of a portable maintenance front end in the distributed data processing system landscape of FIG. 1.

FIG. 9 is a flowchart of a process that can be performed by one or more data processing systems to integrate information for the performance of maintenance activities.

FIG. 10 shows an example teaching round log populated with information describing the performance of maintenance tasks.

FIG. 11 is a flowchart of a process that can be performed to integrate information for the performance of maintenance activities.

FIG. 12 shows an example work list that can be prepared and presented in the process of FIG 11.

FIG. 13 is a schematic representation of a maintenance engine that integrates data for the performance of maintenance activities.

FIGS. 14 and 15 are flowcharts of processes that can be used to generate work lists by interacting with a human user.

FIGS. 16 and 17 are flowcharts of a process that can be performed to dynamically integrate information for the performance of maintenance activities.

Like reference symbols in the various drawings indicate like elements.

### DETAILED DESCRIPTION

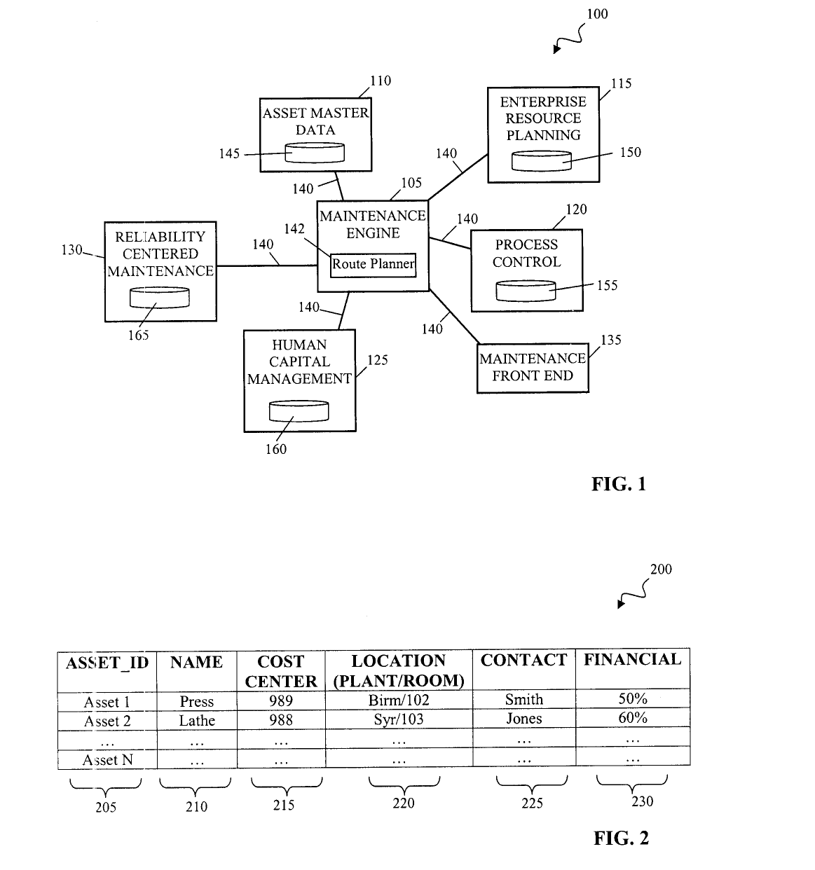

FIG. 1 is a schematic representation of a distributed data processing system landscape 100 where maintenance information is integrated for the performance of maintenance activities. A distributed data processing system landscape can include a collection of data processing devices, software, modules, and/or systems (hereinafter “system”) that operate autonomously yet coordinate their operations across data communication links. By operating autonomously, the systems can operate in parallel, handling local workloads of data processing activities. The data communication link allows information regarding the activities, including the results of performance of the activities, to be exchanged between data processing systems. To these ends, many distributed data processing systems include distributed databases and system-wide rules for the exchange of data. System landscape 100 thus is a collection of systems that exchange information for the performance of one or more data processing activities in accordance with the logic of a set of machine readable instructions.

System landscape 100 includes a maintenance engine 105, an asset master data system 110, an enterprise resource planning system 115, a process control system 120, a reliability centered maintenance system 125, a human capital management system 130, and a maintenance front end 135 that exchange information over a collection of one or more data links 140. Maintenance engine 105 receives and integrates information from one or more of data processing systems 110, 115, 120, 125, 130 and/or front end 135 over data links 140 to plan and coordinate maintenance activities. The planning and coordination of maintenance activities by maintenance engine 105 can include, e.g., the capture of maintenance information during the performance of maintenance activities, the generation of inspection rounds and work lists for maintenance personnel, the processing of such work lists, the dynamic updating of such work lists, and the review of maintenance information and activities.

As part of these planning and coordination activities, maintenance engine 105 can plan a route to be taken by maintenance personnel in the performance of maintenance activities. As discussed further below, the route planning can be performed based on information drawn from one or more of data processing systems 110, 115, 120, 125, 130, and/or front end 135 over data links 140. In some implementations, the route can be dynamically updated to reflect changing maintenance needs of an enterprise. To perform such route planning, maintenance engine 105 can include a route planner 142. Route planner 142 can be a set of data processing activities performed in accordance with the logic of a set of machine-readable instructions. Route planner 142 can be part of maintenance engine 105 (as shown), a stand-alone engine or module, or part of one or more of data processing systems 110, 115, 120, 125, 130, and/or front end 135. In some implementations, the data processing activities of route planner 142 can be based on approaches such as Dijkstra's algorithm, with vertices representing maintenance activities and edge weights integrating the cost of performing those maintenance activities. The costs can reflect a variety of factors, including, e.g., travel time between locations where the maintenance activities are performed, the consequences of delaying the performance of the maintenance activities (e.g., the cost associated with delaying fulfillment of a customer order or the costs associated with having a process-chain remain inoperable), the expertise of the maintenance personnel, the availability of parts and alternative equipment, the nature of the maintenance task to be performed, the capacity load of the affected assets, the sales orders (including scheduling, value, and type of customer) impacted by the maintenance, the production lines and non-maintenance personnel impacted by the maintenance, as well as other parameters. The costs can be tangible (e.g., loss of monetary, loss of time, or the like) or intangible (e.g., loss of reputation, a changed relationship with a customer, or the like). In some implementations, route planner 142 or other data processing activities in system landscape can include additional functionality related to directing maintenance personnel to maintenance tasks. This additional functionality can include, e.g., the ability to locate maintenance personnel that are near to sites where maintenance tasks are to be performed and/or to locate maintenance tasks to be performed in the vicinity of calculated routes between high priority maintenance tasks.

Asset master data system 110 is a system that handles and provides master data regarding the assets of an enterprise. The assets of an enterprise include both movable and fixed equipment and supplies that are relevant to the activities of the enterprise. Assets can be owned and/or operated by the enterprise or by another party.

Master data is information that is common to different locations and/or processes in a system landscape. Master data thus can be referenced by multiple systems and/or applications in a system landscape, such as, e.g., a product lifecycle management system, a customer relationship management system, a supply chain management system, and a manufacturing system. Master data thus may be shared across functional or other boundaries in an enterprise.

Master data can be stored in data objects. A data object is a collection of information that is grouped together to conceptually represent a real-world and treated as a primitive in a data processing environment. A data object is generally free of internal references and information stored in a data object can be changed without concomitant changes to the data processing instructions that handle the data object. The information in a data object can be stored in a contiguous block of computer memory of a specific size at a specific location.

The data in asset master data system 110 can be stored in one or more collections 145. Collection 145 can be a database or other repository of asset master data. The data in collection 145 can be accessed by other systems in system 100.

FIG. 2 schematically illustrates an example collection 200 of asset master data that can be accessed in asset master data system 110 (FIG. 1) to plan and coordinate maintenance activities. Collection 200 is shown as a data table. However, the asset master data in collection 200 can be stored in other formats, including the data objects discussed above, as well as lists, records, arrays, files, and the like. Collection 200 includes an asset ID column 205, an asset name column 210, a cost center column 215, a location column 220, a contact column 225, and a financial column 230.

Asset ID column 205 includes an ID number or other information that identifies one or more assets. Asset ID column 205 can thus include a globally unique ID that identifies a specific asset or an identifier of a class or category of assets that share common characteristics. Asset name column 210 includes a name or other description of the asset(s) identified in asset ID column 205. Thus, asset name column 210 can include, e.g., the name of a specific asset or the name of a class or category of assets that share common characteristics. Asset name column 210 can be particularly helpful when the identifiers in asset ID column 205 are numeric or in another format that is relatively inaccessible to humans.

Cost center column 215 includes an ID number or other information that identifies a cost center responsible for the asset(s) identified in asset ID column 205. Location column 220 includes information that identifies one or more location(s) of the asset(s) identified in asset ID column 205. The location of an asset can be identified in a number of ways, e.g., by country, state, city, site, plant, line, room, position, and the like. Contact column 225 includes name(s) or other information that identifies one or contact people for the asset(s) identified in asset ID column 205. Financial column 230 includes financial information relevant to the asset(s) identified in asset ID column 205.

Returning to FIG. 1, enterprise resource planning system 115 is a system that can be used to plan, administer, and/or optimize the operational business processes of an enterprise. In some implementations, an enterprise resource planning system can manage a variety of information related to an enterprise, including customer, product, employee, and financial data. Thus, in some implementations, other systems in system landscape 100, such as e.g., asset master data system 110, process control system 120, reliability centered maintenance system 125, human capital management system 130, maintenance engine 105, and maintenance front end 135 can be part of enterprise resource planning system 115.

The data in enterprise resource planning system 115 can be stored in one or more collections 150. Collection 150 can be a database or other repository of data related to an enterprise. The data in collection 150 can be accessed by other systems in system 100.

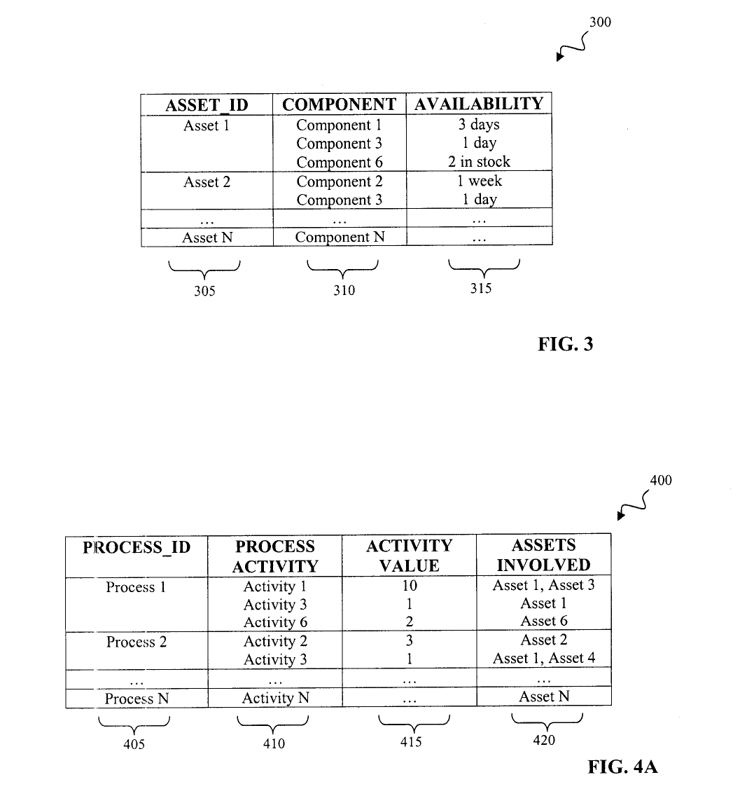

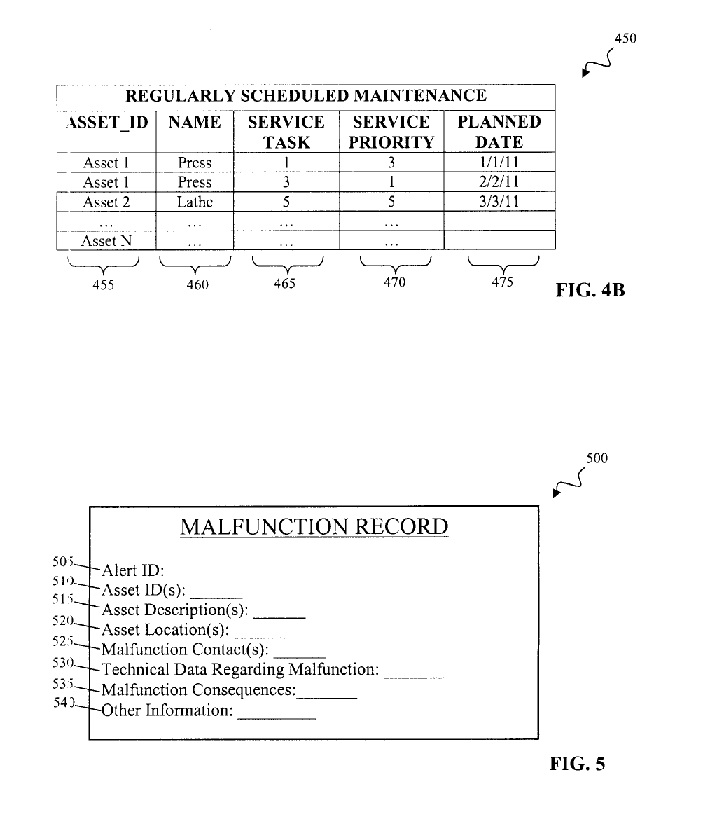

FIGS. 3, 4A, 4B schematically illustrate example collections 300, 400, 450 of data that can be accessed in enterprise resource planning system 115 (FIG. 1) to plan and coordinate maintenance activities. Collections 300, 400, 450 are shown as data tables, but other formats are possible.

Collection 300 includes an asset ID column 305, a component column 310, and a component availability column 315. Asset ID column 305 includes an ID number or other information that identifies one or more assets. Asset ID column 305 can thus include a globally unique ID that identifies a specific asset or an identifier of a class or category of assets that share common characteristics.

Component column 310 includes the names or other identifiers of replaceable components of the asset(s) identified in asset ID column 305. Component column 310 can include identifiers of specific components or of a class or category of components that share common characteristics. Component availability column 315 includes information that identifies the availability of component(s) identified in component column 310. Availability can be described, e.g., in terms of a number of components in stock, time required for delivery, or the like.

Collection 400 includes a process identifier column 405, a process activity column 410, an activity value column 415, and an involved asset column 420. Process identifier column 405 includes an ID number or other information that identifies one or more processes of an enterprise. A process is a set of activities that is performed to achieve an objective of an enterprise. For example, a process can produce a product and/or a service for a customer.

The activities of a process can be performed in response to an event, such as a customer placing an order or the like. The activities can have a defined deliverable or other output. A process can be defined by such a triggering event, along with the activities required to produce the output, any sequential relationship between the activities, decisions that are part of the response, and/or the flow of material and/or information between activities and into and out of the process itself.

Activity value column 415 includes information identifying one or more constituent activities of the processes identified in process identifier column 405. The identifying information can be a numeric identifier, a name, or the like. In some implementations, sequential or other relationships between the activities can be set forth. For example, activities can be describes as alternatives (i.e., one activity is identified as capable of being performed instead of the other) and/or predecessors and successors (i.e., one activity is identified as replacing the other activity).

Process activity column 410 includes information identifying values of the constituent activities of a process. The value of an activity is a measure of the relative worth, utility, or importance of an activity and can be based on the consequences of not performing the activity. The value of an activity can be measured in any of a number of different ways including, e.g., money generated by the activity, the number and type of processes contingent upon performance of the activity, and personnel, storage, and other costs associated with not performing the activity.

Involved asset column 420 includes information describing one or more specific assets, or classes or categories of assets, involved in the performance of an activity. The asset(s) can be identified by an ID number or other identifier. As shown, a single asset (or class/category of assets) can be involved in the performance of multiple activities, including the activities of different processes.

Collection 450 includes an asset ID column 455, an asset name column 460, a service task column 465, a service priority column 470, and a planned service date column 475. Asset ID column 455 includes an ID number or other information that identifies an asset of an enterprise. Asset name column 460 includes a name or other description of the asset identified in asset ID column 455. Service task column 465 includes information that identifies service tasks for the asset identified in asset ID column 455.

Service priority column 470 includes information that describes the priority of the service task identified in service task column 465. Planned service date column 475 includes information that describes the planned date of the service task identified in services task column 465.

Returning to FIG. 1, process control system 120 is a system that can be used to manage and control the performance of processes in the enterprise. As discussed above, a process is a set of activities that is performed to achieve an objective of an enterprise. Process control system 120 can be used to implement and perform control operations to ensure the performance of process activities. Such control operations can include the automated and/or manual monitoring of the performance of process activities, test and assessment of the performance of process activities (including ensuring compliance with regulatory schemes such as Sarbanes-Oxley), and the guidance of human users in the performance of manual monitoring and/or control activities. The type of systems in process control system 120 can depend on the nature of the processes performed by the enterprise. For example, in manufacturing enterprises, process control system 120 can include one or more computer systems for the automated control of manufacturing or other equipment, such as computer numeric control (CNC) systems, alarm systems, diagnostic systems, and the like.

Process control data in process control system 120 can be stored in one or more collections 155. Collection 155 can be a database or other repository of data related to an enterprise. The data in collection 155 can be accessed by other systems in system 100.

FIG. 5 schematically illustrates an example collection 500 of data that can be accessed in a process control system 120 (FIG. 1) in a manufacturing enterprise to plan and coordinate maintenance activities. In particular, collection 500 is directed to recording information that describes a malfunction event, such as when manufacturing equipment malfunctions. Collection 500 is shown as a data record, but other formats are possible.

Collection 500 is a collection of fields 505, 510, 515, 520, 525, 530, 535, 540 that include details describing a malfunction event. Alert ID field 505 includes a number or other identifier of the malfunction event. Asset ID(s) field 510 includes ID number(s) or other information that identifies one or more assets involved in the malfunction event. Asset description(s) field 515 includes a name or other description of the asset(s) involved in the malfunction event. Asset location(s) field 520 includes information that identifies one or more location(s) of one or more assets involved in the malfunction event.

Malfunction contact(s) field 525 includes the name(s) or other information that identifies one or more contact people with information regarding the malfunction event. Technical data regarding malfunction field 530 includes technical information regarding the malfunction event. The technical information can include, e.g., the results of diagnostic or other measurements performed on assets involved in the malfunction event. Malfunction consequences field 535 can include information regarding the consequences of the malfunction event. Examples of such information includes information regarding the impact of the malfunction event on certain processes, the impact of the malfunction event on the current operating capacity of assets involved in the event, the availability of any alternatives, and/or any safety issues arising due to the malfunction. Other information field 540 can include other information regarding the malfunction event. Examples of such other information include comments by individuals familiar with the malfunction event and other information not captured in fields 505, 510, 515, 520, 525, 530, 535.

Returning to FIG. 1, human capital management system 125 is a system for managing the human capital of an enterprise. For example, human capital management system 130 can store information regarding the employees of a company and their interactions with the company. For example, human capital management system 125 can be used to manage employee benefits, compensation, recruitment, training, payroll, performance evaluations, employee profiles, and the like. Human capital management system 125 can also be used to ensure that interactions between employees and a company comply with regulatory or other schemes.

Human capital data in human capital management system 125 can be stored in one or more collections 160. Collection 160 can be a database or other repository of data related to an enterprise. The data in collection 160 can be accessed by other systems in system 100.

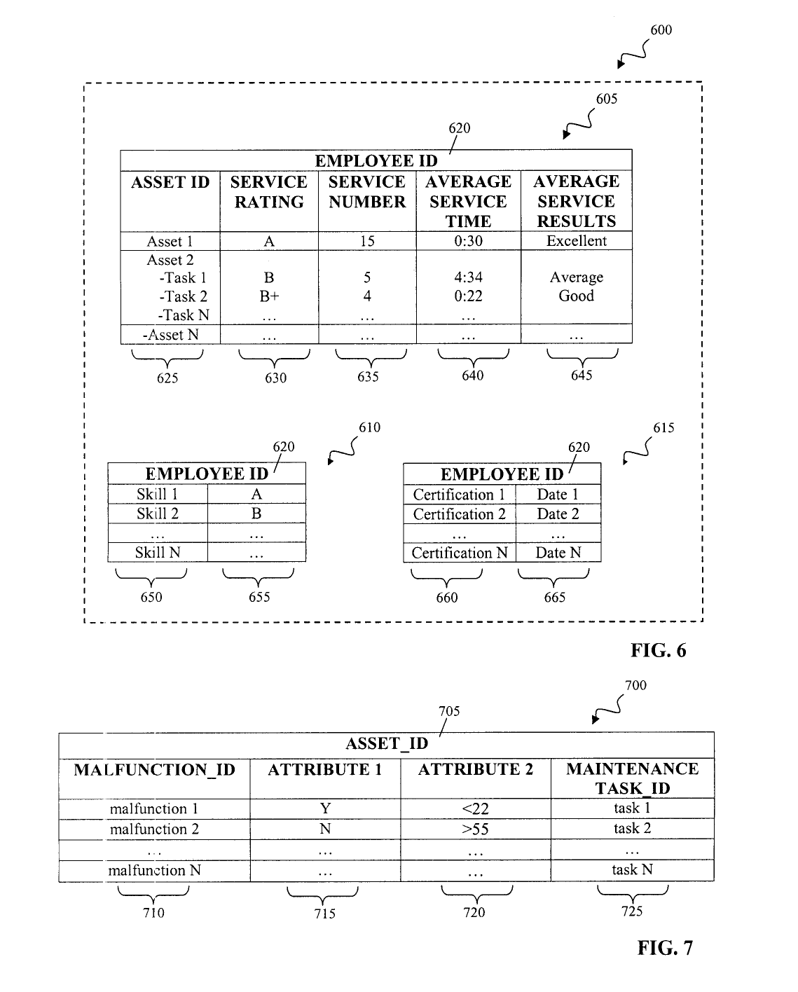

FIG. 6 schematically illustrates an example collection 600 of human capital data that can be accessed in a human capital management system 125 (FIG. 1) to plan and coordinate maintenance activities. In particular, collection 600 is directed to recording information that describes the potential of an employee to perform maintenance activities. Collection 600 is shown as an a collection of employee records 605, 610, 615 that are each in the form of a data table, but other formats are possible.

Each employee record 605, 610, 615 includes a header 620 that identifies an employee or other participant in an enterprise by name or otherwise. Employee record 605 also includes an asset ID column 625, a service rating column 630, a service number column 635, in average service time column 640, and an average service result column 645.

Asset ID column 625 includes an ID number or other information that identifies an asset of an enterprise. Asset ID column 625 can also include information that identifies service tasks for an asset. Service tasks are maintenance operations that are intended to decrease the likelihood of poor performance or failure of an asset. By way of illustration, example service tasks for an automobile asset include changing the oil, replacing the cap and rotor, flushing the radiator, and the like.

Service rating column 630 includes information that summarizes the service rating of the individual identified in header 620 on the asset and/or the service task(s) identified in asset ID column 625. The service rating of an individual can reflect an estimate of the capacity of the individual identified by header 620 to perform one or more relevant maintenance operations on an asset identified in asset ID column 625.

Service number column 635 includes information that describes the number of performances of one or more relevant maintenance operations on an asset identified in asset ID column 625 by the individual identified in header 620. Average service time column 640 includes information that describes the average time used to perform one or more relevant maintenance operations on an asset identified in asset ID column 625 by the individual identified in header 620. An average service result column 645 includes information that describes the average quality of the performance of one or more relevant maintenance operations on an asset identified in asset ID column 625 by the individual identified in header 620. In some implementations, the service rating in service rating column 630 can reflect the number of performances described in service number column 635, the average service described in average service time column 640, the average service result described in average service result column 645, and/or other factors.

Employee record 610 includes a skill column 650 and a skill rating column 655. Skill column 650 includes information that identifies a skill that is relevant to the performance of maintenance operations. Examples of such skills can include, e.g., electrician, welder, plumber, and the like. Skill rating column 655 includes information that summarizes the rating of the individual identified in header 620 in the skill identified in skill column 650. The rating of an individual can reflect, e.g., the number of maintenance tasks performed using a skill, the duration that an individual has possessed a skill, a qualification of the individual (e.g., whether an individual is a “master electrician”), and the like.

Employee record 615 includes a certification column 660 and a certification date column 665. Certification column 660 includes information that identifies a certification that is relevant to the performance of maintenance operations. The certification can be legal, such as an electricians certification, a certification to handle waste, or a certification to operate equipment, such as a truck or a welding device. Certification date column 665 includes information that describes the effective date of the certification identified in certification column 660.

Returning to FIG. 1, reliability centered maintenance system 130 is a system that can be used to determine maintenance strategies for ensuring that enterprise assets are able to fulfill their intended functions. Reliability centered maintenance system 130 can determine such maintenance strategies based on reliability data and information regarding the assets, as well as the risk and consequences of failure to perform maintenance tasks such as when a bottle-neck in a business process results from the failure to perform a maintenance task. For example, reliability centered maintenance system 130 can be an expert system or the like directed to ensuring that maintenance operations are performed timely and appropriately to decrease the likelihood of poor performance or failure.

Maintenance data in reliability centered maintenance system 130 can be stored in one or more collections 165. Collection 165 can be a database or other repository of data related to an enterprise. The data in collection 165 can be accessed by other systems in system 100.

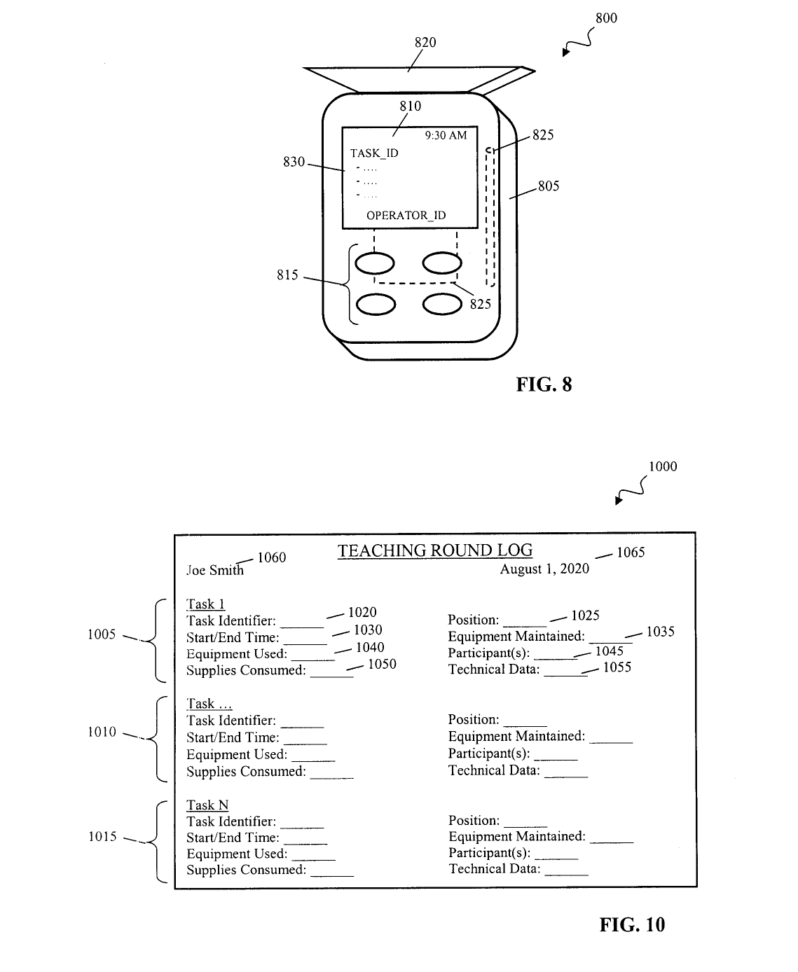

FIG. 7 schematically illustrates an example collection 700 of maintenance data that can be accessed in a reliability centered maintenance system 130 (FIG. 1) to plan and coordinate maintenance activities. In particular, collection 700 is directed to recording information that can be used by an expert or other system in determining whether maintenance tasks are to be performed. Collection 700 is shown as a data table, but other formats are possible.

Collection 700 includes an asset identifier 705 that associates the information in collection 700 with the identified asset. Collection 700 also includes a malfunction identifier column 710, and a collection of one or more attribute columns 715, 720, and a maintenance task identifier column 725. Malfunction identifier column 710 includes information that identifies a malfunction that can hinder of prevent the operation of the asset identified in asset identifier 705.

Attribute columns 715, 720 include information that characterizes the malfunction identified in malfunction identifier column 710. For example, attribute column 715 describes whether or not an “attribute 1” is associated with the malfunction identified in malfunction identifier column 710 and attribute column 720 describes the values of a parameter “attribute 2” that are associated with the malfunction identified in malfunction identifier column 710. An expert or other system can determine whether one or more malfunctions identified in malfunction identifier column 710 plagues the asset identified by asset identifier 705 by comparing technical or other information associated with the asset to the information in attribute columns 715, 720.

Maintenance task identifier column 725 includes information that identifies one or more maintenance tasks that can be performed to remedy the malfunctions identified in malfunction identifier column 710. In some implementations, additional details regarding the maintenance tasks, such as equipment used and time and supplies consumed in the performance of the maintenance tasks, along with the skills needed to perform the maintenance tasks, can also be included in collection 700 (not shown).

Returning to FIG. 1, maintenance front end 135 is a system for interacting with a human user for the planning and performance of maintenance activities. Maintenance front end 135 typically requests maintenance-related services from maintenance engine 105 and other systems in landscape 100 to plan and coordinate maintenance activities.

Maintenance front end 135 can be a portable device that can be carried by a human user. FIG. 8 schematically illustrates an example of a portable maintenance front end 135, namely, a handheld device 800.

Handheld device 800 includes a casing 805 that is dimensioned to be held in the hand of a human user. Casing 805 includes an output 810, an input 815, one or more interrogation devices 820, and houses one or more network interfaces 825 and data processing devices 830. Output 810 is output device for communicating information to a human user. For example, output 810 can be an LCD or other screen. Among the information communicated to a human user can be a list of maintenance-related tasks 830, as discussed further below. Input 815 is an input device for receiving information from a human user. For example, input 815 can be collection of buttons, a keypad, a touchpad, or the like.

Interrogation device 820 is one or more devices configured to read information from electronically-accessible, machine-readable tags associated with an asset or other device. Such tags can be mounted on, affixed to, or otherwise associated with a device such that a relationship between the tag and the device is established. Examples of such tags include, e.g., active and passive RFID tags, integrated circuit (IC) microprocessor cards and memory cards, optical memory cards, barcodes, tags that can be applied on a molecular basis, smart cards, or other computer-readable storage devices.

An interrogation device 820 can be a device capable of reading from such tags. Examples of interrogation device 820 include, e.g., an optical scanner, a transceiver, a molecular reader, a card reader, a card-accepting device, or other device for reading data. In some implementations, interrogation device 820 may also be able to write to a machine-readable tag.

Network interface 825 is one or more devices that allow handheld device 800 to receive and transmit data over a data link 140 (FIG. 1) and interact with maintenance engine 105 and other systems in landscape 100 to plan and coordinate maintenance activities. The maintenance activities can include, e.g., confirming the performance of maintenance tasks, recording technical and other measurement results, and the like. The type of network interface 825 can be selected based on the nature of data link 140. For example, although network interface 825 is shown as an internal antenna for communicating over a wireless data link 140, network interface 825 can also be, e.g., an external antenna and/or a wired connection, such as a wired data port.

Data processing device 830 is one or more devices for performing data processing activities in accordance with the logic of a set of machine-readable instructions. The activities performed by data processing device 830 can include managing, e.g., the interaction with a human user over output 810 and input 815, the interaction between interrogation device 820 and machine-readable tags, and the interaction between handheld device 800 and the remainder of system landscape 100 over network interface 825.

In some implementations, handheld device 800 can also include a locator device and/or an internal clock. A locator device is a device that provides information indicative of the location of handheld device 800. One example of a locator device is a global positioning system (GPS) device or the like. Handheld device 800 need not include a locator device and/or a clock to access time and location information. Instead, location and time information can be determined based on information received from other devices. For example, the interrogation of a tag that is associated with a fixed asset can yield a GUID or other identifier of the fixed asset. Such an identifier can be used to access asset master data to identify the location of the fixed asset and the handheld device 800. As another example, time information can be received from another system in landscape 100 over data link 140.

Returning to FIG. 1, as discussed above, data processing systems 110, 115, 120, 125, 130 and/or front end 135 in landscape 100 integrate information for the performance of maintenance activities. Such integration facilitates maintenance of the assets of an enterprise. In particular, asset malfunctions can be avoided and/or remedied in a timely manner. Downtime can be reduced or even avoided. Maintenance resources can be efficiently deployed and the net cost of maintenance activities to an enterprise can be reduced.

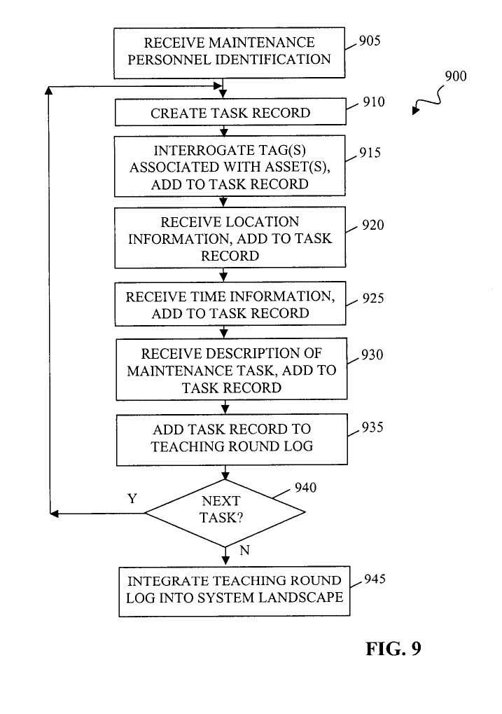

FIG. 9 is a flowchart of a process 900 that can be performed by one or data processing systems in landscape 100 (FIG. 1) to integrate information for the performance of maintenance activities. For example, process 900 can be performed by front end 135, alone or in conjunction with maintenance engine 105, to initiate and/or update data storage in one or more of data processing systems 110, 115, 120, 125, 130.

In particular, front end 135 can receive an identification of one or more maintenance personnel at 905. Maintenance personnel are one or more human individuals who are responsible for the performing maintenance tasks. Maintenance personnel can be identified by name, by employee number, or otherwise. Front end 135 can receive the maintenance personnel identification, e.g., when the maintenance personnel enters the identification over input 815, by scanning or otherwise interrogating a barcode or other tag associated with the maintenance personnel using interrogation device 820, and/or from another data processing system in landscape 100 over network interface 825.

Front end 135 can create a task record at 910. A task record is a collection of information that describes a particular maintenance task. The task record can be structured as, e.g., a data record, a data object, a table, a file, or an entry in these or other data structures. The task record can be created in response to prompting from the identified maintenance personnel. When created, the task record can initially be empty and prepared for population with maintenance task information.

Front end 135 can interrogate one or more tags associated with one or more assets that are to participate in a maintenance task and add the obtained information to the task record at 915. The information obtained from an interrogated asset can be a GUID or other identifier of the asset. In some implementations, additional information such as maintenance history, operational records, and the like may also be accessed by interrogating a tag associated with an asset.

As discussed above, assets can be movable or fixed equipment or supplies. Thus, multiple assets can participate in a single maintenance task in different roles. For example, a fixed asset may be repaired in a maintenance task, whereas asset supplies can be consumed in repairing the fixed asset. Multiple fixed assets can also participate in the same maintenance task.

Since the role of an asset in a maintenance task can vary, the information obtained by interrogating a tag can be added to a task record in a variety of ways. For example, supplies consumed during a maintenance task can be denoted in a task record as such. As another example, equipment used to perform the maintenance activities can be denoted as such in a task record.

In some implementations, other information regarding the maintenance task can be determined from the information obtained by interrogating tags and then added to a task record. For example, the nature of a maintenance task may be discernable based on the supplies consumed during the performance of a maintenance task. For example, if one liter of engine oil is consumed during the performance of a maintenance task on an automobile, one or more data processing systems in landscape 100 can determine that the maintenance task is topping off the engine oil of the automobile. One the other hand, if four liters of engine oil are consumed, one or more data processing systems in landscape 100 can determine that the maintenance task is changing the engine oil of the automobile. Such determined information can be added to the task record as well.

Front end 135 can receive location information identifying where the maintenance task is performed and add the location information to the task record at 920. The location information can be received, e.g., over a GPS or other location device included in front end 135 or from one or more other data processing systems in system landscape 100. For example, front end 135 can transmit an identifier of a fixed asset obtained by interrogating a tag associated with that asset at 915 to assert master data system 110 over network interface 825 and data link 140. Asset master data system 110 can access asset master data in collection 145 (such as collection 200 (FIG. 2)) to determine the location where the maintenance activity is performed. This information can be returned to front end 135 and added to the task record.

Front end 135 can receive time information identifying the timing of the performance of the maintenance task and add the time information to the task record at 925. The time information can be received, e.g., from an internal clock in the front end or from a data processing system in system landscape 100. The timing information can identify the beginning and the end of the performance of the maintenance tasks. The beginning and the end can be identified, e.g., based on maintenance personnel input received over input 815.

Front end 135 can receive a description of the maintenance task and add the description to the task record at 925. The description can be received, e.g., from maintenance personnel over input 815. As discussed above, a description can also be determined based on information obtained by interrogating tags associated with one or more assets. Such a determined description can be received from one or more processing systems in system landscape 100 over network interface 825 and data link 140.

The description information can include information describing, e.g., the nature of the maintenance task, the difficulty of the particular maintenance tasks, information regarding the cause of the any malfunction addressed by the maintenance task, as well as additional commentary by the maintenance personnel who performed the task.

Front end 135 can add the task record to a teaching round log at 935 and determine if another task is to be performed at 940. If another task is to be performed, front end 135 can return to 910 to create another task record. If another task is not to be performed, front end 135 can integrate the teaching round log into the system landscape at 945. The integration of a teaching round log can involve the incorporation of information obtained at 910, 915, 920, 925, 930 into one or more data collections in system landscape 100. For example, information from a teaching round log can be incorporated into one or more of collection 200 (FIG. 2), collection 300 (FIG. 3), collection 400 (FIG. 4A), collection 450 (FIG. 4B), collection 500 (FIG. 5), collection 600 (FIG. 6), and collection 700 (FIG. 7). The incorporation of such information can be done to “teach” system landscape by providing system landscape with information regarding the actual performance of maintenance tasks.

FIG. 10 shows an example teaching round log 1000. Teaching round log 1000 includes a collection of task records 1005, 1010, 1015 that are each populated with information describing the performance of maintenance tasks. The populating information can be obtained during the performance of the tasks or after the performance is complete. The populating information can be obtained by interacting with humans or assets that participate in the task or determined based on information obtained from such interactions. Teaching round log 1000 can be structured as, e.g., a data record, a data object a table, a file, or an entry in these or other data structures.

As shown, each task record 1005, 1010, 1015 can include information 1020 identifying the task (such as the name of the task or the like), information 1025 identifying the location where the task is performed, information 1030 identifying the duration of the task performance, information 1035 identifying any equipment maintained by performance of the task, information 1040 identifying any equipment used in the performance of the task (such as tools, diagnostic equipment, or the like), information 1045 identifying any human participants in the performance of the task, information 1050 identifying any supplies consumed in performance of the task, and information 1055 describing technical details associated with the performance of the task. The technical details can include, e.g., the results of diagnostic or other tests performed before and/or after the performance of the task. Teaching round log 1000 can also include fields or other records 1060, 1065 that include information identifying maintenance personnel, the date of task performance, the skills needed to perform the maintenance tasks, and the like.

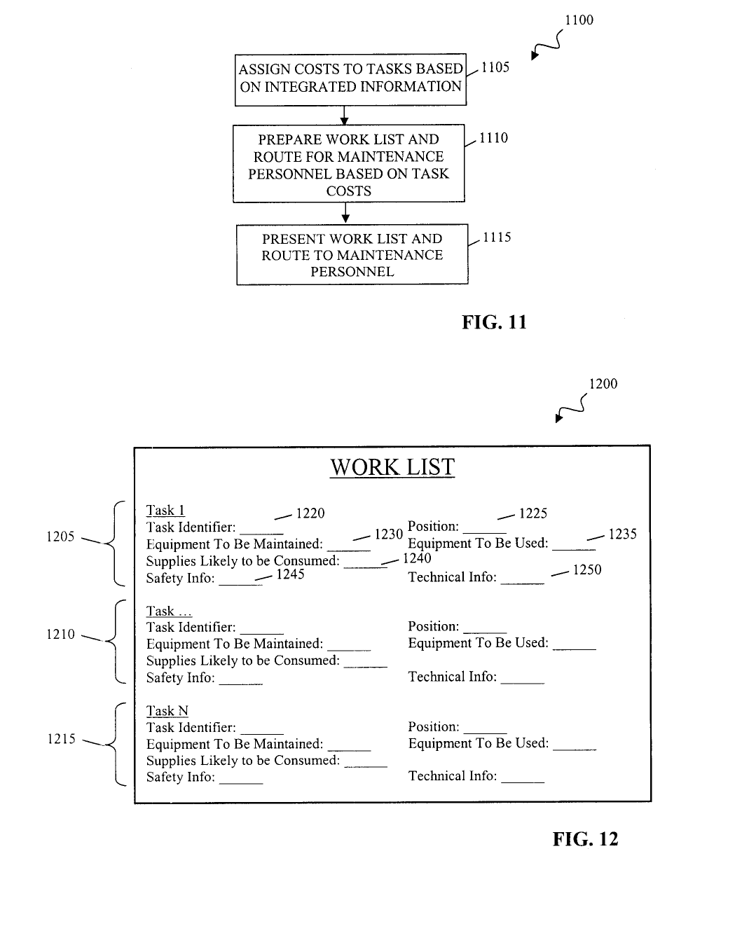

FIG. 11 is a flowchart of a process 1100 that can be performed by one or data processing systems in landscape 1100 (FIG. 1) to integrate information for the performance of maintenance activities. For example, process 1100 can be performed in whole or in part by maintenance engine 105 to integrate data stored in one or more of data processing systems 110, 115, 120, 125, 130.

The system performing process 1100 can assign costs to maintenance tasks based on integrated information at 1105. The integrated information can be drawn from one or more of data processing systems 110, 115, 120, 125, 130. For example, information drawn from collection 200 (FIG. 2), collection 300 (FIG. 3), collection 400 (FIG. 4A), collection 450 (FIG. 4B), collection 500 (FIG. 5), collection 600 (FIG. 6), and/or collection 700 (FIG. 7) can be used to assign a cost associated with a failure to perform a maintenance task. The assigned cost can thus reflect factors such as, e.g., travel time between the sites where maintenance is to be performed, the availability and location of components that may participate in the maintenance task, the involvement of assets that are to participate in the maintenance activities in certain processes, the value of those processes to the enterprise, technical information regarding the assets (including any malfunction of the assets and the like), the abilities and experience of maintenance personnel, the availability of alternative equipment, the nature of the maintenance task to be performed, the capacity load of the affected assets, the sales orders (including scheduling, value, and type of customer) impacted by the maintenance, the production lines and non-maintenance personnel impacted by the maintenance, and the like. Costs can be assigned to both regularly scheduled maintenance services and maintenance tasks performed in response to acute situations, such as a malfunction.

Based on the assigned costs, the system performing process 1100 can prepare a work list and a route for one or more maintenance personnel at 1110. The work list can be a list of tasks that are the responsibility of one or more maintenance personnel. For example, a work list can set forth the maintenance tasks for one individual. A route is a path for the maintenance personnel to move from one location where maintenance is performed to another. The route can include a set of human-readable directions for moving from one location to another.

The system performing process 1100 can also present the prepared work list and the route to one or more maintenance personnel at 1115. The work list and the route can be presented as a whole or on a task-by-task and location-by-location basis. The work list and the route can be presented by conveying data describing the work list and the route to maintenance front end 135 for output to maintenance personnel.

FIG. 12 shows an example work list 1200 that can be prepared and presented at 1110, 1115 in process 1100 (FIG. 11). Work list 1200 includes ordered descriptions of one or more maintenance tasks 1205, 1210, 1215 that are the responsibility of one or more maintenance personnel. Each maintenance task description 1205, 1210, 1215 can be populated with integrated information drawn from one or more of data processing systems 110, 115, 120, 125, 130. For example, information for maintenance task description 1205, 1210, 1215 can be drawn from collection 200 (FIG. 2), collection 300 (FIG. 3), collection 400 (FIG. 4A), collection 450 (FIG. 4B), collection 500 (FIG. 5), collection 600 (FIG. 6), and collection 700 (FIG. 7). Work list 1200 can be structured as, e.g., a data record, a data object, a table, a file, or an entry in these or other data structures.

As shown, each maintenance task description 1205, 1210, 1215 can include information 1220 identifying the task (such as the name of the task or the like), information 1225 identifying the location where the task is performed, information 1230 identifying any equipment to be maintained by performance of the task, information 1235 identifying any equipment likely to be used in the performance of the task (such as tools, diagnostic equipment, or the like), information 1240 identifying any supplies likely to be consumed in performance of the task, information 1240 identifying any safety issues likely to arise during the performance of the task, and information 1250 describing technical details associated with the performance of the task. The technical details can include, e.g., the results of diagnostic or other tests performed on equipment to be maintained. Safety information 1240 can include, e.g., material safety information, material and equipment handling instructions, certifications needed to perform the maintenance tasks and the like.

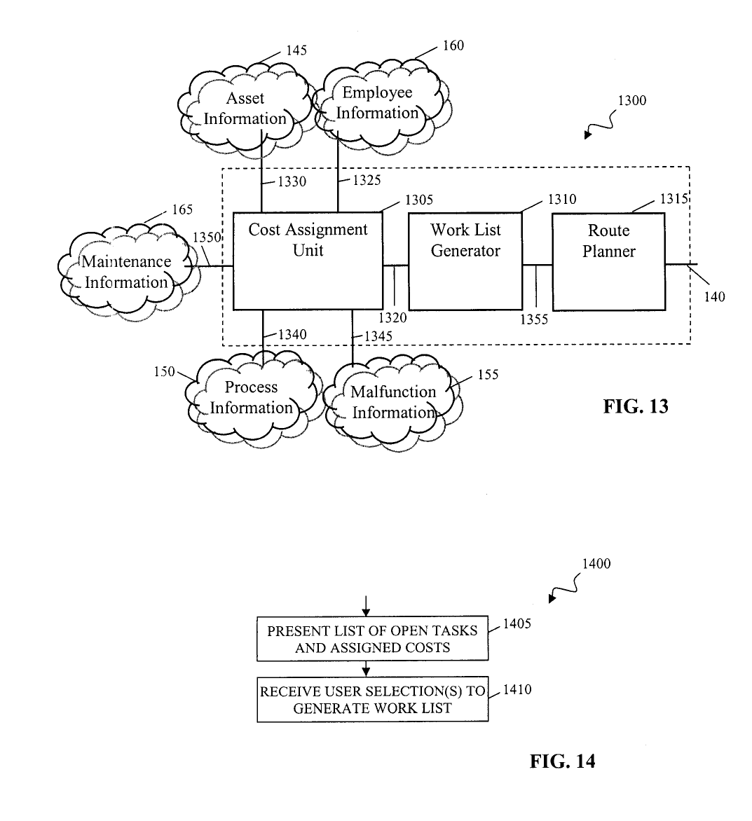

FIG. 13 is a schematic representation of an example implementation of a maintenance engine 1300 that integrates data stored in system landscape 100 for the performance of maintenance activities. Maintenance engine 1300 can perform process 1100 (FIG. 11) to integrate data stored in system landscape 100 automatically, e.g., without interaction with a human user, or interactively.

Maintenance engine 1300 includes a cost assignment unit 1305, a work list generator 1310, and a route planner 1315. Cost assignment unit 1305 is a set of data processing activities performed in accordance with the logic of machine-readable instructions. Cost assignment unit 1305 has one or more outputs 1320 that are input into work list generator 1310. Cost assignment unit 1305 also includes one or more employee information inputs 1325, one or more asset information inputs 1330, one or more maintenance information inputs 1335, one or more process information inputs 1340, one or more malfunction information inputs 1345, and one or more maintenance information inputs 1350.

Cost assignment unit 1305 can receive information over inputs 1325, 1330, 1335, 1340, 1345, 1350 from any of a variety of sources. For example, employee information can be received over employee information inputs 1325 from human capital management system 130. Asset information can be received over asset information inputs 1330 from asset master data system 110. Process information can be received over process information inputs 1340 from enterprise resource planning system 115. Malfunction information can be received over malfunction information inputs 1345 from process control system 120. Maintenance information can be received over maintenance information inputs 1350 from reliability centered maintenance system 125. As discussed above there is no inherent constraint in the arrangement of information storage in landscape 100 and thus different types of information can be received from different systems. As one example, in some implementations, maintenance information may be received from asset master data system 110.

Cost assignment unit 1305 can use the received information to assign costs to maintenance tasks in a variety of different ways. For example, cost assignment unit 1305 can be a rule-based system (such as an expert system) that assigns costs in accordance with the logic of a set of rules based on characteristics of the maintenance tasks. Cost assignment unit 1305 can also assign costs to maintenance tasks by weighting various characteristics of the maintenance tasks in accordance with a collection of weighting factor. The weighting factors can be input by a human user or derived automatically, e.g., using machine learning techniques such as neural networks. In any case, the estimated costs can express the relationship between the maintenance activities and the structure and objectives of the enterprise.

Work list generator 1310 is a set of data processing activities performed in accordance with the logic of machine-readable instructions. In addition to input 1320 from cost assignment unit 1305, work list generator 1310 includes one or more outputs 1355 to route planner 1315. Route planner 1315 is also a set of data processing activities performed in accordance with the logic of machine-readable instructions and includes one or more outputs that can convey data to other systems in system landscape 100 over data link 140. For example, route planner 1315 can convey data to maintenance front end 135.

In operation, cost assignment unit 1305 accesses and integrates information from system landscape for the performance of maintenance activities. Using the received historical information, cost assignment unit 1305 can estimate the costs associated with performing and failing to perform maintenance activities.

Work list generator 1310 receives a description of open maintenance tasks and the costs assigned to those tasks from cost assignment unit 1305. With the received maintenance task descriptions and the assigned costs, work list generator 1310 generates one or more work lists for one or more maintenance personnel. Work list generator 1310 then relays the work list(s) to route planner 1315 over output 1355. Route planner 1315 receives the work list(s) and prepares one or more route plans for the maintenance personnel.

In some implementations, the functionality of work list generator 1310 and route planner 1315 can be combined into a single set of data processing activities. Such a set can define a work list based on potential routes that maintenance personnel would have to follow. For example, work lists can be defined based on the ability of two different maintenance personnel to arrive at the same location at the same time, so that a maintenance task that requires two such personnel can be performed.

Maintenance engine 105 need not perform processes such as process 1100 automatically, i.e., in the absence of interaction with a human user. For example, in some implementations, maintenance engine 105 can interact with a human user for the performance of maintenance activities. As one example, FIG. 14 shows a process 1400 that can be used by a maintenance engine 105 to generate one or more work lists by interacting with a human user. For example, process 1400 can be performed at 1110 in process 1100 (FIG. 11).

The system performing process 1400 can present a list of open tasks and their assigned costs to a human user at 1405. The human user can be the maintenance personnel responsible for performing the maintenance tasks or another human user, such as a maintenance manager or the like. The list of open tasks can be presented, e.g., over output 810 of a handheld maintenance front end 800 (FIG. 8).

The system performing process 1400 can receive selections from the human user to generate one or more work lists at 1410. For example, the selections can be received over input 815 of a handheld maintenance front end 800 (FIG. 8).

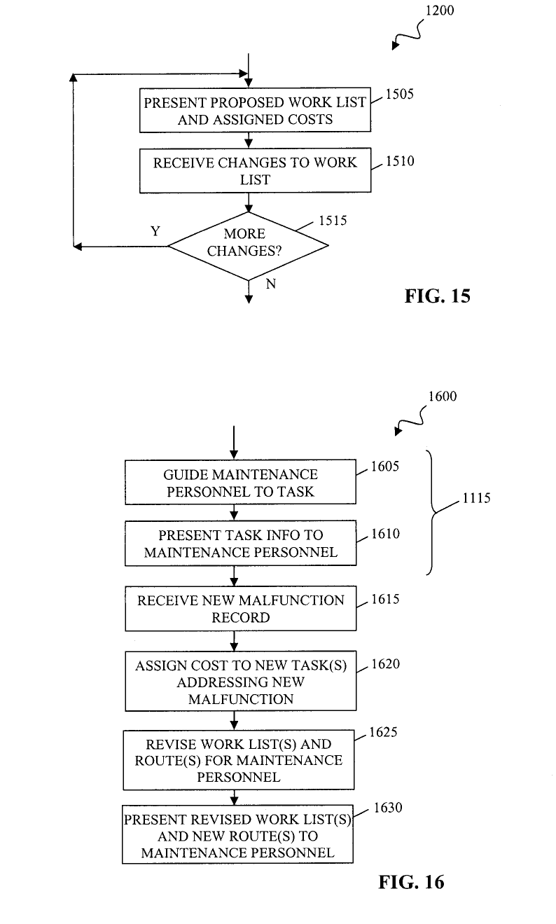

As another example of interaction between maintenance engine 105 and a human user for the performance of maintenance activities, FIG. 15 shows a process 1500 that can be used by a maintenance engine 105 to generate one or more work lists by interacting with a human user. For example, process 1500 can also be performed at 1110 in process 1100 (FIG. 11).

The system performing process 1500 can present a proposed work list and the costs assigned to various tasks in the work list to a human user at 1505. The human user can be the maintenance personnel responsible for performing the maintenance tasks described on the work list or another human user, such as a maintenance manager or the like. The proposed work list can be presented, e.g., over output 810 of a handheld maintenance front end 800 (FIG. 8).

The system performing process 1500 can receive changes to the proposed work list at 1510. For example, a human user can delete a task from the work list, rearrange the order of performance, indicate that the time allotted for performance of a task is improper, or otherwise modify the work lists. The modifications can be received over input 815 of a handheld maintenance front end 800 (FIG. 8).

The system performing process 1500 can determine if more changes are to be received at 1515. The determination can be made, e.g., based on input received from the human user or automatically, such as when the changed task list meets a criterion. If the system determines that more changes are to be received, the system returns to 1505 to present a proposed task list that includes the previously-received modifications.

In some implementations, the information that is to be integrated for the performance of maintenance activities can change rather quickly, for example, during the course of a single day. The present inventors have recognized that data processing systems can dynamically update task lists and other maintenance information is response to changed circumstances. Such dynamic updates can be performed quickly but yet consider information drawn from diverse data processing systems, such as those in landscape 100 (FIG. 1).

FIG. 16 is a flowchart of a process 1600 that can be performed by one or more data processing systems in landscape 100 (FIG. 1) to dynamically integrate information for the performance of maintenance activities. Process 1600 can be performed in isolation or in conjunction with other data processing activities. For example, process 1600 (an be performed as part of and in conjunction with process 1100 (FIG. 11).

The system performing process 1600 can guide maintenance personnel to a location where a maintenance task is to be performed at 1605. The system can also present information related to the performance of the task at 1610. The guidance and task performance information can be presented to maintenance personnel on a task-by-task and a location-by-location basis, e.g., over output 810 of a handheld maintenance front end 800 (FIG. 8). The guidance and task performance information can be part of the presentation of a work list and a route to maintenance personnel at 1115 in process 1100 (FIG. 11).

At some point, the system performing process 1600 can receive a malfunction record at 1615. The malfunction record can be received, e.g., from a system such as process control system 120 (FIG. 1). The system performing process 1600 can assign costs to one or more maintenance tasks that respond to the new malfunction at 1620. The costs can be assigned based on integrated information drawn from one or more of data processing systems 110, 115, 120, 125, 130. The costs can also reflect the distance that maintenance personnel must travel in order to perform the maintenance task.

The system performing process 1600 can revise one or more work lists and one or more route plans for one or more maintenance personnel based on the costs assigned to the responsive maintenance task(s) at 1625. The revisions can reflect the costs associated with the new maintenance tasks. For example, if a new maintenance task is very costly not to perform, the new maintenance task can be inserted into the top slot of a work list and a route to the location where the new task is to be performed can be planned. The revised work list and route plan can be presented to one or more maintenance personnel at 1630). For example, the revised work list and route plan can be presented over output 810 of a handheld maintenance front end 800 (FIG. 8).

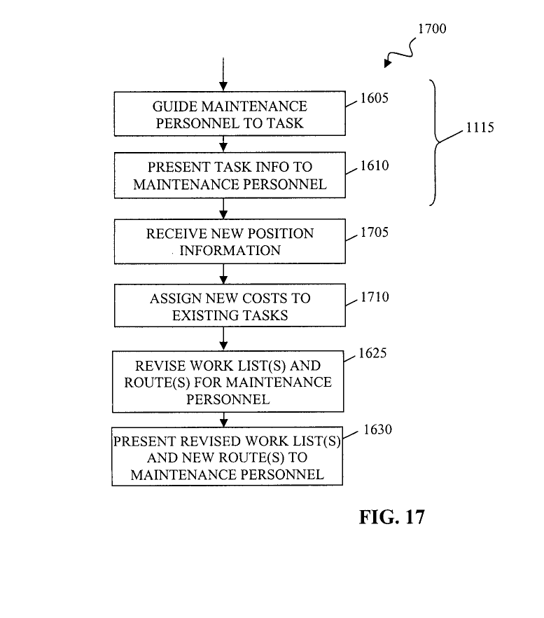

FIG. 17 is a flowchart of a process 1700 that can be performed by one or more data processing systems in landscape 100 (FIG. 1) to dynamically integrate information for the performance of maintenance activities. Process 1700 can be performed in isolation or in conjunction with other data processing activities. For example, process 1700 can be performed as part of and in conjunction with process 1100 (FIG. 11).

The system performing process 1700 can guide maintenance personnel to a location where a maintenance task is to be performed at 1605 and present information related to the performance of the task at 1610.

At some point, the system performing process 1700 can receive information that indicates that the maintenance personnel has moved to a new position at 1705. The new position information can be received, e.g., from a handheld maintenance front end 800 (FIG. 8) that includes a GPS or other positioning device. The new position of the maintenance personnel can reflect, e.g., that the maintenance personnel has taken a break, gone to lunch, accompanied a colleague to another position, or otherwise left a prior position.

The system performing process 1700 can assign new costs to open maintenance tasks in light of the new position of the maintenance personnel at 1710. The costs can be assigned based on integrated information drawn from one or more of data processing systems 110, 115, 120, 125, 130. The newly assigned costs can reflect the new position of the maintenance personnel and the distance that the maintenance personnel must travel in order to perform the maintenance tasks.

The system performing process 1600 can revise one or more work lists and one or more route plans for one or more maintenance personnel based on the costs assigned to the responsive maintenance task(s) at 1625 and present the revised work list and route plan to one or more maintenance personnel at 1630. The maintenance personnel can include the maintenance personnel whose new position was indicated at 1705, as well as other maintenance personnel.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing environment that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the environment can be interconnected by any form or medium of digital data communication (e.g., a communication network). Examples of communication networks include a local area network (“LAN”), a wide area network (“WAN”), and the Internet.

A number of implementations have been described. Nevertheless, it will be understood that various modifications may be made. For example, the information in data collections 200, 300, 400, 450, 500, 600, 700 can be divided between one or more systems in system landscape 100 for storage. For example, the information associated in asset ID column 305 and component column 310 of data collection 300 (FIG. 3) can be stored in asset master data system 110, whereas the information associated in asset ID column 305 and component availability column 315 can be stored in enterprise resource planning system 115. As another example, information regarding the impact of a malfunction can be drawn from a reliability centered maintenance system.

Additional systems and/or data storage capability can be added. For example, information drawn from an EBP (Enterprise Buyer Professional) system can also be integrated into maintenance scheduling by a maintenance engine.

As another example, a route planner can be contained in a separate system or in a system other than the maintenance engine but yet accessed by the maintenance engine to integrate information for the planning and performance of maintenance activities. Accordingly, other implementations are within the scope of the following claims.

What is claimed is:

1. A method comprising:
receiving a collection of descriptions of maintenance tasks in an enterprise;
accessing one or more data stores to receive asset information characterizing assets in the enterprise, process information characterizing assets involved in processes of the enterprise, and process value information characterizing values of the processes to the enterprise;
integrating the asset information, the process information, and the process value information to assign costs associated with performance of each of the maintenance tasks;
generating a work list including a subset of the collection of maintenance tasks based on the assigned costs; and
making the work list available over one or more output devices.

2. The method of claim 1, wherein:
the data stores are accessed to receive human resource information characterizing abilities of maintenance personnel to perform the maintenance tasks; and
the human resource information, the asset information, the process information, and the process value information are integrated to assign the costs.

3. The method of claim 1, wherein making the work list available comprises outputting the work list at an output device on a task-by-task and location-by location basis.

4. The method of claim 1, wherein receiving the collection of descriptions of maintenance tasks comprises descriptions of regularly-scheduled maintenance tasks in the enterprise.

5. The method of claim 1, further comprising planning a route for maintenance personnel to perform the maintenance tasks on the work list.

6. The method of claim 5, wherein the route is planned based on the costs assigned to each of the maintenance tasks.

7. The method of claim 1, further comprising:
after generating the work list, receiving a notification of a malfunction of an asset of the enterprise;
accessing and integrating the asset information, the process information, and the process value information to assign a cost associated with a failure to perform a maintenance task responsive to the malfunction;
revising the work list to include the maintenance task responsive to the new malfunction; and
making the revised work list available to the maintenance personnel over the one or more output devices.

8. The method of claim 1, further comprising:
after generating the work list, receiving an indication that maintenance personnel has moved to a new position;
accessing and integrating the asset information, the process information, and the process value information to assign revised costs associated with performance of each of the maintenance tasks;
revising the work list in light of the revised costs; and
making the revised work list available to the maintenance personnel over the one or more output devices.

9. An article comprising one or more machine-readable media storing instructions operable to cause one or more machines to perform operations comprising:
receiving information characterizing a past performance of maintenance activities, the information characterizing the past maintenance activities, an entity performing the past maintenance activities, one or more assets involved in the past maintenance activities, and the duration of the performance of the past maintenance activities;
storing the past performance information in one or more collections of information;
integrating the past performance information with information characterizing participation of assets in processes of an enterprise and values of the processes to the enterprise to assign costs to open maintenance tasks of the enterprise;
generating a work list including a subset of the open maintenance tasks; and
making the work list available.

10. The article of claim 9, wherein the operations further comprise:
after generating the work list, receiving a notification of a malfunction of first asset of the enterprise;
accessing and integrating the past performance information with the information characterizing participation of the first asset in processes of the enterprise and values of the processes to the enterprise to assign a cost to a first maintenance task responsive to the malfunction;
revising the work list to include the first maintenance task; and
making the revised work list available.

11. The article of claim 9, wherein the past performance information comprises information read from a machine-readable tag associated with the one or more assets involved in the past maintenance activities.

12. The article of claim 9, wherein the past performance information further comprises information characterizing quality of the past performance of the maintenance activities.

13. The article of claim 9, wherein the past performance information is stored in data collections associated with different modules of a distributed data processing system.

14. The article of claim 9, wherein travel time between locations where maintenance tasks are performed is integrated to assign costs to open maintenance tasks of the enterprise.

15. The article of claim 9, wherein availability of equipment or supplies consumed for performance of maintenance tasks is integrated to assign costs to open maintenance tasks of the enterprise.

16. The article of claim 9, wherein the operations further comprise making safety information characterizing safety issues associated with performance of the maintenance tasks available to the maintenance personnel.

17. The article of claim 9, wherein the work list is made available to maintenance personnel over one or more handheld front-end devices on a task-by-task basis.

18. The article of claim 9, wherein assigning the costs comprises:
multiplying each of one or more elements of the past performance information, the information characterizing participation of assets in processes, and the process values by factors reflective of a cost indicated by that information; and
summing the factors to assign the costs to the open maintenance tasks.

19. The article of claim 9, wherein generating the work list comprises determining a route to be taken by maintenance personnel in the performance of the open maintenance tasks in the work list.

20. The article of claim 9, wherein determining the route comprises selecting the subset of the open maintenance tasks based on maximizing a total cost associated with not performing the selected subset or minimizing a total cost associated with performing the selected subset.
